(19) United States
(12) Patent Application Publication
(10) Pub. No.: US 2026/0206027 A1
(43) Pub. Date: Jul. 16, 2026

(54) SYSTEMS AND METHODS FOR CAPACITY EXPANSION OF CONTROL CHANNEL

(71) Applicant: ZTE CORPORATION, Shenzhen (CN)

(72) Inventors: Junli LI, Shenzhen (CN); Nan ZHANG, Shenzhen (CN); Wei CAO, Shenzhen (CN); Fangyu CUI, Shenzhen (CN)

(73) Assignee: ZTE CORPORATION, Shenzhen (CN)

(21) Appl. No.: 19/559,060

(22) Filed: Mar. 6, 2026

Related U.S. Application Data
(63) Continuation of application No. PCT/CN2023/122945, filed on Sep. 28, 2023.

(51) Int. Cl. H04W 72/21; H04L 1/1812

(52) U.S. Cl. CPC H04W 72/21; H04L 1/1812

(57) ABSTRACT

Presented are systems and methods for capacity expansion of control channel. A wireless communication device (e.g., UE) may receive a first indication of a physical uplink control channel (PUCCH) resource for PUCCH transmission from a wireless communication node (e.g., BS). The wireless communication device can determine the PUCCH resource to perform the PUCCH transmission.

### CROSS-REFERENCE TO RELATED APPLICATION

This application claims the benefit of priority under 35 U.S.C. § 120 as a continuation of PCT Patent Application No. PCT/CN2023/122945, filed on Sep. 28, 2023, the disclosure of which is incorporated herein by reference in its entirety.

### TECHNICAL FIELD

The disclosure relates generally to wireless communications, including but not limited to systems and methods for capacity expansion of control channel.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., UE) can receive/acquire/obtain a first indication of a physical uplink control channel (PUCCH) resource for PUCCH transmission from a wireless communication node (e.g., BS, gNB, or transmission and reception point (TRP)). The wireless communication device can determine the PUCCH resource to perform the PUCCH transmission.

In some implementations, the PUCCH resource can comprise at least one of: a PUCCH resource for PUCCH transmission for a msg4 hybrid automatic repeat request acknowledgement (HARQ-ACK), a PUCCH resource for PUCCH transmission with repetition, for a msg4 HARQ-ACK, a common PUCCH resource for PUCCH transmission, and/or a common PUCCH resource for PUCCH transmission with repetition.

In some implementations, the first indication can comprise at least one of: a second indication: comprising an index to indicate a defined set of PUCCH resources with a corresponding set of initial cyclic shift (CS) indexes, received via higher layer signaling, a third indication: comprising at least one physical resource block (PRB) offset, received via higher layer signaling, a fourth indication: comprising at least one PRB offset relative to a cell-common PRB offset value, received via higher layer signaling, and/or a fifth indication: comprising an indicator in downlink control information (DCI) signaling to indicate to the wireless communication device to expand resources in one PUCCH resource set. The indicator can be included in at least one of: a downlink assignment index (DAI) field, a modulation and coding scheme (MCS) field, and/or a reserved field, in DCI format 1_0. In some implementations, the higher layer signaling can be at least one of system information block (SIB) signaling, medium access control (MAC) signaling, radio resource control (RRC) signaling, and/or other signalings.

In some implementations, the corresponding set of initial CS indexes can comprise: four, six, or eight initial CS indexes. In some implementations, each wireless communication device with a different capability or configuration on repetition factors, can be sequentially mapped to a respective subset of the corresponding set of initial CS indexes. The sequential mapping can comprise at least one of: initial CS indexes belonging to a wireless communication device with repetition enabled and a wireless communication device with repetition disabled, each occupy half of the corresponding set of initial CS indexes when only a single repetition factor is configured; all of the initial CS indexes belong to a wireless communication device with repetition enabled when only a single repetition factor is configured; initial CS indexes belonging to a wireless communication device with repetition disabled, a wireless communication device with a first repetition factor and a wireless communication device with a second repetition factor respectively are {first initial CS index}, {second initial CS index, third initial CS index}, {fourth initial CS index, fifth initial CS index, sixth initial CS index} when only two repetition factors are configured; initial CS indexes belonging to a wireless communication device with repetition disabled, a wireless communication device with a first repetition factor and a wireless communication device with a second repetition factor respectively are {first initial CS index, second initial CS index}, {third initial CS index, fourth initial CS index}, {fifth initial CS index, sixth initial CS index} when only two repetition factors are configured; initial CS indexes belonging to a wireless communication device with first repetition factor and a wireless communication device with second repetition factor each occupy half of the corresponding set of initial CS indexes when only two repetition factors are configured; initial CS indexes belonging to a wireless communication device with repetition disabled, a wireless communication device with a first repetition factor, a wireless communication device with a second repetition factor and a wireless communication device with a third repetition factor respectively are {first initial CS index}, {second initial CS index}, {third initial CS index, fourth initial CS index}, {fifth initial CS index, sixth initial CS index} when only three repetition factors are configured; initial CS indexes belonging to a wireless communication device with a first repetition factor, a wireless communication device with a second repetition factor and a wireless communication device with a third repetition factor respectively are {first initial CS index}, {second initial CS index}, {third initial CS index, fourth initial CS index} when only three repetition factors and four initial CS indexes are configured; and/or initial cyclic shifts belonging to a wireless communication device with a first repetition factor, a wireless communication device with a second repetition factor and a wireless communication device with a third repetition factor respectively are {first initial CS index, second initial CS index}, {third initial CS index, fourth initial CS index}, {fifth initial CS index, sixth initial CS index} when only three repetition factors and six initial CS indexes are configured; initial CS indexes belonging to a wireless communication device with a first repetition factor, a wireless communication device with a second repetition factor and a wireless communication device with a third repetition factor respectively are {first initial CS index}, {second initial CS index, third initial CS index}, {fourth initial CS index, fifth initial CS index, sixth initial CS index} when only three repetition factors and six initial CS indexes are configured; and/or initial CS indexes for a wireless communication device can be determined as legacy values when no repetition factor is configured or when the wireless communication device is not capable of repetition.

In some implementations, for wireless communication devices with same capability or configuration on repetition factors, each respective wireless communication device may be determined to have a specific initial CS index according to at least one of:

$${r}_{PUCCH} mod {N}_{C S}^{′} ,$$

and/or

$$( {r}_{p u c c h} - 8 ) mod {N}_{C S}^{′} ,$$

wherein

$${N}_{CS}^{′}$$

can be a total of initial CS indexes in the corresponding set of initial CS indexes corresponding to one repetition factor, wherein r_{pucch} can be a PUCCH index of the respective wireless communication device.

In some implementations, the second indication may be received via at least one of: a PUCCH-ConfigCommon information element (IE), a pucch-ResourceCommonRep field, and/or another field of the PUCCH-ConfigCommon IE. In some implementations, at least one of: the third indication comprises at least one PRB offset

$$( R {B}_{B W P}^{offset} )$$

in frequency domain; and/or the fourth indication comprises at least one PRB offset

$$( {RB}_{B W P}^{offset - relative} )$$

relative to a cell-common PRB offset value. The at least one PRB offset can comprise at least one of: −2, 0, 2, 4, 6, and/or another integer value.

In some implementations, the third or fourth indication may be received via at least one of: a PUCCH-ConfigCommon information element (IE) and/or a pucch-PRBoffsetValue field. In some implementations, each wireless communication device with a different capability or configuration on repetition factor, can be sequentially mapped to a respective subset of the at least one PRB offset, where the sequential mapping can comprise at least one of:

$$R {B}_{B W P}^{offset}$$

is used for a wireless communication device with repetition disabled for PUCCH transmission,

$$R {B}_{B W P}^{offset} + R {B}_{B W P}^{offset - relative 1}$$

is used for a wireless communication device with a first, second or third repetition factor for PUCCH transmission, when only one

$$R {B}_{B W P}^{offset - relative 1}$$

is configured;

$$R {B}_{B W P}^{offset}$$

is used for a wireless communication device with repetition disabled and for a wireless communication device with a first repetition factor for PUCCH transmission,

$$R {B}_{B W P}^{offset} + R {B}_{B W P}^{offset - relative 1}$$

is used for a wireless communication device with a second or third repetition factor for PUCCH transmission, when only

$$R {B}_{B W P}^{offset - relative 1}$$

is configured;

$$R {B}_{B W P}^{offset}$$

is used for a wireless communication device with repetition disabled and a wireless communication device with a first repetition factor for PUCCH transmission,

$$R {B}_{B W P}^{offset} + R {B}_{B W P}^{offset - relative 1}$$

is used for a wireless communication device with a second repetition factor for PUCCH transmission,

$$R {B}_{B W P}^{offset} + R {B}_{B W P}^{offset - relative 2}$$

is used for a wireless communication device with a third repetition factor for PUCCH transmission, when

$$\{ R {B}_{B W P}^{offset - relative 1} , R {B}_{B W P}^{offset - relative 2} \}$$

are configured; and/or

$$R {B}_{B W P}^{offset}$$

is used for a wireless communication device with repetition disabled for PUCCH transmission,

$$R {B}_{B W P}^{offset} + R {B}_{B W P}^{offset - relative 1}$$

is used for a wireless communication device with a first repetition factor for PUCCH transmission,

$$R {B}_{B W P}^{offset} + R {B}_{B W P}^{offset - relative 2}$$

is used for a wireless communication device with a second repetition factor for PUCCH transmission,

$$R {B}_{B W P}^{offset} + R {B}_{B W P}^{offset - relative 3}$$

is used for a wireless communication device with a third repetition factor for PUCCH transmission, when

$$\{ {RB}_{B W P}^{offset - relative 1} , R {B}_{B W P}^{offset - relative 2} , {RB}_{B W P}^{offset - relative 3} \}$$

are configured.

In some implementations, for wireless communication devices with same capability or configuration on repetition, each respective wireless communication device can be determined to use a specific PRB offset according to one of: UE_{ID} mod N_{PRBoffset}, when multiple PRB offsets are configured, where N_{PRBoffset} is a total number of PRB offsets defined, UEDD is a wireless communication device network identification which can comprise at least one of: a Cell-Radio Network Temporary Identifier (C-RNTI), a Temporary Cell-Radio Network Temporary Identifier (TC-RNTI), an International Mobile Subscriber Identity (IMSI), and/or another identifier of the respective wireless communication device.

In some implementations, the fifth indication can comprise one or more bits in a DAI field or MCS field or reserved field in DCI format 1_0, that expands or forms a range of a PUCCH resource indicator (PRI). In some implementations, determining the PUCCH resource can comprise: determining, by the wireless communication device, the PUCCH resource to perform the PUCCH transmission, when a condition associated with the first indication is met, wherein the condition associated with the first indication being met comprises at least one of: a number of repetition for PUCCH repetition is configured via system information block (SIB) signaling; a reference signal received power (RSRP) threshold for determining whether to perform PUCCH repetition is configured via SIB signaling; a specific number of repetition is indicated by a downlink assignment index (DAI) field in downlink control information (DCI) format 1_0; the wireless communication device reporting that the wireless communication device is capable of supporting PUCCH repetition; an index in a second indication is larger than 15; and/or a pucch-ResourceCommonRep field is used to configure an index in a PUCCH resource set table regardless of whether a pucch-ResourceCommon field is configured or not. The PUCCH repetition can comprise repetition of at least one of: PUCCH for Msg4 hybrid automatic repeat request acknowledgement (HARQ-ACK), and/or common PUCCH.

In some implementations, at least one of: the RSRP threshold can be configured via higher layer signaling; when a measured RSRP is below the RSRP threshold, the wireless communication device can report its capability to support PUCCH repetition; when the RSRP threshold is not configured, the wireless communication device can report its capability to support PUCCH repetition; the RSRP threshold can be an absolute value or a relative value; and/or the relative value can be relative to a defined or legacy RSRP threshold (e.g., RSRP threshold for Msg3 repetition).

In some implementations, when the relative value is zero, at least one of: the RSRP threshold for PUCCH repetition can be same as a defined or legacy RSRP threshold if the defined or legacy RSRP threshold is configured, and/or the RSRP threshold for PUCCH repetition may not be configured if the defined or legacy RSRP threshold is not configured. In some implementations, when the relative value is non-zero, at least one of: the RSRP threshold for PUCCH repetition can be the defined or legacy RSRP threshold plus the non-zero value, and/or the RSRP threshold for PUCCH repetition can be the defined or legacy RSRP threshold minus the non-zero value.

At least one aspect is directed to a system, method, apparatus, or a computer-readable medium of the following. A wireless communication node can send/transmit/provide/communicate a first indication of a physical uplink control channel (PUCCH) resource for PUCCH transmission (e.g., to a wireless communication device). The PUCCH resource can be determined according to the first indication to perform PUCCH transmission.

The systems and methods presented herein include a novel approach for capacity expansion of control channel. Specifically, the systems and methods presented herein discuss a novel solution for supporting a larger set of initial cyclic shift for instance to enhance PUCCH resource multiplexing capability. The systems and methods can support additional PRB offset to improve the number of PUCCH resources, such as to avoid collision between multiple UEs. The systems and methods can support expanding the number of PUCCH resources in one set by enhancing the PUCCH resource indicator and/or aggregation level of CORESET. In some cases, the systems and methods can include or provide RSRP threshold configuration for PUCCH repetition. In various aspects, the conditions or parameters for implementing, incorporating, or taking the enhanced channel can include but not limited to receiving, by a wireless communication device, an indication indicating a PUCCH resource (e.g., for PUCCH transmission) and determining the PUCCH resource to perform the PUCCH transmission, for example. In some configurations, the PUCCH resources may include, for example, the PUCCH resource can be PUCCH resource for Msg4 HARQ-ACK, a PUCCH repetition resource for Msg4 HARQ-ACK, and/or a common PUCCH resource, etc. Additional or alternative conditions can be applied, not limited to those discussed herein.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a non-terrestrial network (NTN), in accordance with some embodiments of the present disclosure;

FIG. 4 illustrates an example of UE states transitions, in accordance with some embodiments of the present disclosure; and

FIG. 5 illustrates a flow diagram of an example method for capacity expansion of control channel, in accordance with an embodiment of the present disclosure.

### DETAILED DESCRIPTION

### 1. Mobile Communication Technology and Environment

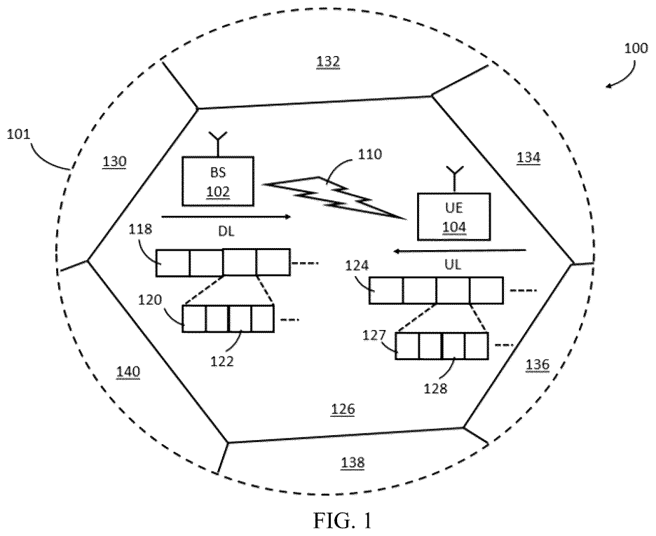

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

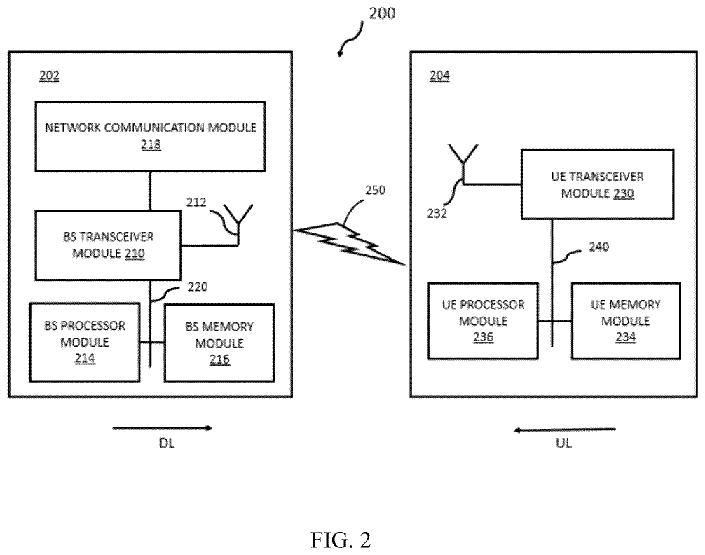

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Capacity Expansion of Control Channel

In certain communication systems, uplink (UL) coverage enhancements can be provided or specified to enhance new radio (NR) non-terrestrial network (NTN) enhancements, such as repetitions and demodulation reference signal (DMRS) bundling, to name a few. For example, certain systems may support physical uplink control channel (PUCCH) repetition for Msg4 hybrid automatic repeat request acknowledgment (HARQ-ACK). The single repetition factor can be configured by a system information block (SIB). The multiple repetition factors can be configured by the SIB and the exact repetition factor can be indicated by downlink assignment index (DAI) field in the downlink control information (DCI).

In some cases, when the repetition is not configured, the common PUCCH resource used for PUCCH for Msg4-HARQ-ACK may be based on the predefined PUCCH resource sets. In a certain PUCCH resource set, there may be 16 PUCCH resources (e.g., constrained to 16 PUCCH resources in certain systems). In this case, the UE 104 can determine the PUCCH resource based on the PUCCH resource indicator in DCI 1_0 and/or DCI 1_1, and the index of the control channel element (CCE) in which the physical downlink control channel (PDCCH) scheduling the PUCCH was received, for example.

However, the utilization of the repetitions may reduce the system capacity (or resource) and/or the throughput of one or more UEs 104 (e.g., user throughput), for instance, by reducing the resources available for data (or communication) including for UEs 104 and/or the BS 102, among other devices within the communication system. In some cases, using the repetitions feature may increase the transmission time of the UE 104, thereby increasing the utilization of UL resources in the time domain, before being released to other users. When repetition is configured and repetition factor is configured larger than 1 (e.g., 2, 4, or 8, sometimes provided as {2,4,8}), various time domain PUCCH resources may be consumed because of the limited frequency domain resource and/or sequence domain resource. In such cases, other UE(s) may have relatively insufficient PUCCH resources and/or may experience a relatively longer wait time or delay for transmission of PUCCH, thereby increasing the average access time delay of the UEs 104 in the cell. For example, with the constraint of 16 resources available in an NTN-cell, if for instance 8 repetitions are applied, a limited of 16 resources may be available within the 8 slots, and the available resources may reduce from 128 (e.g., 16*8) to 16. Further, the PUCCH capacity may be insufficient due to the expected or potential number of UEs 104 (e.g., the numerous amount of users) being within a particular satellite or BS coverage, among other NTN devices or terrestrial network (TN) devices. Hence, the systems and methods of the technical solution discussed herein can provide features or operations to enhance the capacity of common PUCCH resource sets, thereby alleviating the insufficiency of the PUCCH resource in certain systems. By executing the features or operations discussed herein to enhance the PUCCH resource sets capacity (e.g., increasing or adjusting the capacity), the systems and methods can decrease, minimize, or otherwise maintain the transmission time of various network devices (e.g., the UEs 104 and/or BS 102), reduce the UL resource utilization in the time domain, reduce the potential wait time or delay for transmission of PUCCH, and/or minimize the average access time delay of the UEs 104 within the cell, to provide a few examples.

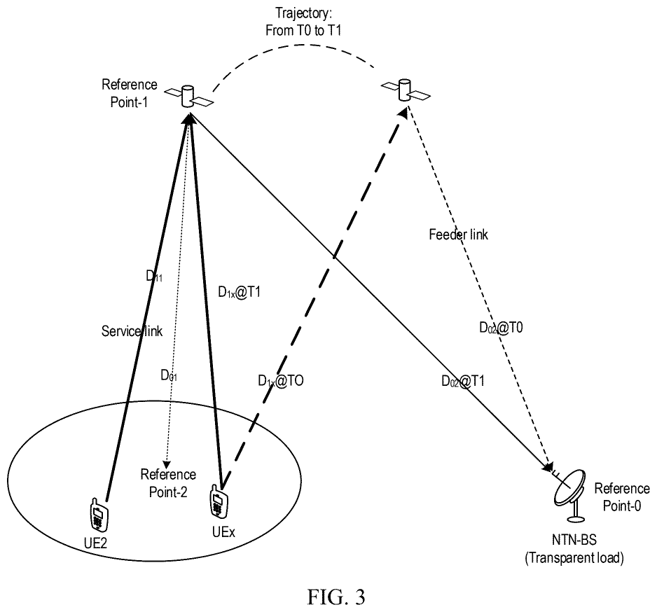

FIG. 3 illustrates an example structure of a transparent NTN, in accordance with some embodiments of the present disclosure. A link between a UE (e.g., a user equipment, the UE 104, the UE 204, a mobile device, a wireless communication device, a terminal, etc.) and a satellite can be a service link. A link between a BS (e.g., a base station, the BS 102, the BS 202, a gNB, an eNB, a wireless communication node, etc.) and a satellite can be a feeder link and can be common for all UEs within the same cell.

In certain networks, the UE 104 may not have a dedicated PUCCH resource configuration, such as provided by PUCCH-ResourceSet in PUCCH-Config, for example. In this case, a PUCCH resource set can be provided by pucch-ResourceCommon through/via an index to a row of a specification or configuration, such as but not limited to example Table 1, for transmission of HARQ-ACK information on PUCCH in an initial UL bandwidth part (BWP) of

$${RB}_{B W P}^{offset}$$

physical resource blocks (PRBs). For operation in a certain frequency range (e.g., FR2-2, etc.), nrofPRBs provided in PUCCH-ConfigCommon can provide a number of N_{RB} RBs for the PUCCH resource set. The N can denote a value, including not limited to a predetermined number of RBs in this case. Otherwise, if the N_{RB} is not provided, a predefined (or default) value can be utilized, e.g., N_{RB}=1.

The PUCCH resource set can include 16 resources. Each of the PUCCH resource set can correspond to or be associated with a PUCCH format, a first symbol, a duration, a PRB offset

$$R {B}_{B W P}^{offset} ,$$

and/or a cyclic shift index set for a PUCCH transmission. If the UE 104 provides/transmits/sends HARQ-ACK information in a PUCCH transmission in response to detecting/identifying a DCI format scheduling a physical downlink shared channel (PDSCH) reception or having associated HARQ-ACK information without scheduling a PDSCH reception, the UE 104 may determine a PUCCH resource with but not limited to index r_{PUCCH}, 0≤r_{PUCCH}≤15,

$${r}_{PUCCH} = ⌊ \frac{2 \cdot {n}_{CCE , 0}}{{N}_{CCE}} ⌋ + 2 \cdot {Δ}_{PRI} .$$

In this case, the N_{CCE} can be a number of CCEs in a CORESET of a PDCCH reception with the DCI format. Further, n_{CCE,0} can be the index of a first CCE for the PDCCH reception. The Δ_{PRI} can represent a value of the PUCCH resource indicator field in the DCI format.

If └r_{PUCCH}/8┘=0 and the UE 104 is provided (or received/acquired) a PUCCH resource, such as via/by pucch-ResourceCommon, and is not provided with useInterlacePUCCH-PUSCH in BWP-UplinkCommon, the UE 104 can perform/execute at least one of the following:
The UE 104 can determine/identify the relatively lowest/smallest PRB index of the PUCCH transmission in the first hop as

$$R {B}_{B W P}^{offset} \cdot {N}_{R B} + ⌊ {r}_{P U C C H} / {N}_{C S} ⌋ \cdot {N}_{R B} ,$$

and the relatively lowest PRB index of the PUCCH transmission in the second hop as

$${N}_{B W P}^{s i z e} - R {B}_{B W P}^{offset} \cdot {N}_{R B} - ( 1 + ⌊ {r}_{PUCCH} / {N}_{CS} ⌋ ) \cdot {N}_{R B} .$$

The N_{CS} can denote the total number of initial cyclic shift indexes in the set of initial cyclic shift indexes.
The UE 104 may determine the initial cyclic shift index in the set of initial cyclic shift indexes as r_{PUCCH} mod N_{CS}, for example.

In some aspects, if └r_{PUCCH}/8┘=1 and the UE 104 is provided a PUCCH resource via/by pucch-ResourceCommon and is not provided useInterlacePUCCH-PUSCH in BWP-UplinkCommon, the UE 104 may execute/perform at least one of the following operations or features:
The UE 104 can determine the relatively lowest/smallest PRB index of the PUCCH transmission in the first hop as

$$R {B}_{B W P}^{offset} \cdot {N}_{R B} + ⌊ {r}_{PUCCH} / {N}_{CS} ⌋ \cdot {N}_{R B}$$

and the relatively lowest PRB index of the PUCCH transmission in the second hop as

$${N}_{B W P}^{s i z e} - R {B}_{BWP}^{offset} \cdot {N}_{RB} - ( 1 + ⌊ {r}_{PUCCH} / {N}_{CS} ⌋ ) \cdot {N}_{R B} .$$

The N_{CS} can denote total number of initial cyclic shift indexes in the set of initial cyclic shift indexes.
The UE 104 can determine the initial cyclic shift index in the set of initial cyclic shift indexes as (r_{PUCCH})mod N_{CS}.

Example Table 1:
PUCCH resource sets before dedicated PUCCH resource configuration.

| Index | PUCCH format | First symbol | Number of symbols | $\begin{matrix}PRB offset \\ {RB}_{B W P}^{offset}\end{matrix}$ | Set of initial CS indexes |
|---|---|---|---|---|---|
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $⌊ {N}_{B W P}^{s i z e} / 4 ⌋$ | {0, 3, 6, 9} |

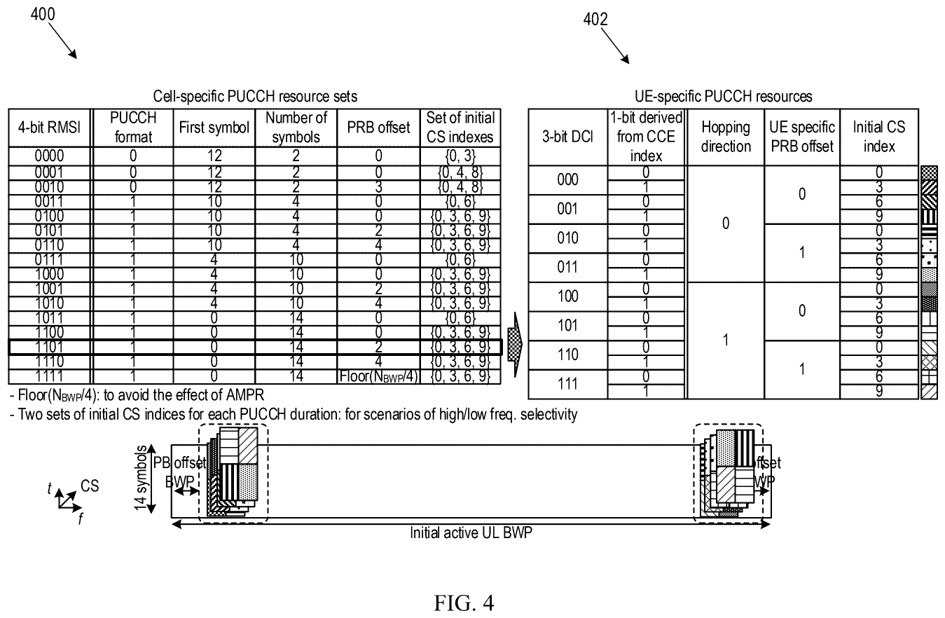

FIG. 4 illustrates an example of UE states transitions, in accordance with some embodiments of the present disclosure. The example table 400 of FIG. 4 can be for cell-specific PUCCH resource sets. In some aspects, the example table 400 may correspond to or be associated with the example Table 1. The example table 402 of FIG. 4 can be for UE-specific PUCCH resources. For example, the example table 402 can provide that, for each PUCCH resource set, 16 resources can be included.

In some arrangements, the UE 104 can determine the PUCCH format, first symbol, number of symbols, PRB offset, and/or cyclic shift index set based on or according to the obtained row index (e.g., system message SIB1→PUCCH Config Common→PUCCH Resource Common). The first symbol and/or the number of symbols can indicate/represent the time domain resources of PUCCH. The PRB offset can indicate the frequency domain resources of PUCCH. For example, the PUCCH format 0 and/or PUCCH format 1 can have a frequency domain length of 1 RB, and can involve the determination of the starting position). The PRB offset can be used/utilized to reduce/minimize inter-cell PUCCH interference (e.g., in the last row of the example table 400, the PRB offset can be ¼ BWP bandwidth, used for cells with relatively high interference). The cyclic shift index set can indicate the available values of m0, and the number of elements can determine (or be used to determine) the multiplexing capacity of PUCCH. In the initial access stage, as the PUCCH configuration is obtained from broadcasting, the UEs 104 within the cell can use a similar (or the same) PUCCH format, for example.

Still referring to FIG. 4, if the PUCCH resource common is 13 (e.g., as shown in the example table 400), the cyclic shift set can include or correspond to {0,3,6,9}, the number of elements N_{CS} can be 4, and/or the multiplexing capacity of PUCCH can be 4. The 16 PUCCH resources in this PUCCH resource set may be divided into 4 groups, corresponding to N_{CS}={0,3,6,9}, such as shown in the example table 400.

### Example PUCCH Multiplexing Capability

In various implementations, for dedicated PUCCH transmission, the maximum N_{CS} that is supported may be 12 symbols, configured by but not limited to initialCyclicShifts. In some cases, in addition or alternative to the number of initial cyclic, multi-user (or multi-UE) multiplexing capacity may depend on the relatively smaller length (e.g., corresponding to the number of symbols) of the orthogonal coverage code used in the DMRS and control information.

With the DMRS and the control information of PUCCH format 1 each occupying half symbols, if intra-slot frequency-hopping is disabled/deactivated, and according to PUCCH occupying a maximum of 14 symbols, the relatively smaller number of symbols in DMRS and control information can be a maximum of 7 symbols. If intra-slot frequency-hopping is activated/enabled, each hop can include/contain a maximum of 7 symbols, and the relatively smaller number of symbols in the DMRS and control information can include or be a maximum of 3 symbols. As described herein, with the symbol 14 as an example, if the intra-slot frequency-hopping is disabled, the maximum multiplexing capacity can equal to or correspond to 7*12=84. In another example, if intra-slot frequency-hopping is activated, the maximum multiplexing capacity can equal to or correspond to 3*12=36.

For common PUCCH transmission, the maximum N_{CS} supported can be 4 symbols. Time-domain orthogonal cover code with index 0 can be used for a PUCCH resource. For instance, time-domain multiplexing capacity can be 1. Therefore, PUCCH for Msg4 HARQ-ACK can support frequency domain multiplexing and sequence domain multiplexing.

### Example Information Element (IE) PUCCH-ConfigCommon

The IE PUCCH-ConfigCommon may be used to configure the cell-specific PUCCH parameters, such as described in conjunction with but not limited to FIG. 4. A non-limiting example of the PUCCH-ConfigCommon IE can be provided as follows.

### Example PUCCH-ConfigCommon IE

PUCCH-ConfigCommon ::= SEQUENCE {
pucch-ResourceCommon INTEGER (0..15) OPTIONAL, -- Cond
InitialBWP-Only
}

In various aspects, when the repetition is not configured for the UE 104, the common PUCCH resource used for PUCCH for Msg4-HARQ-ACK may be according to or based on the predefined PUCCH resource sets. In a particular PUCCH resource set, 16 PUCCH resources may be configured, which allows a maximum of four UEs 104 to multiplex because of limited frequency domain resources (e.g., 1 RB). To prevent/avoid insufficient PUCCH capacity, at least one of but not limited to sequence-domain and/or frequency-domain can be considered to provide increased occasions to transmit PUCCH for Msg4 HARQ-ACK because repetition occupies multiple time transmission occasions.

In some implementations, PUCCH transmission can include or correspond to PUCCH for Msg4 HARQ-ACK, and/or PUCCH repetition for Msg4 HARQ-ACK, among others. Different repetition factors can be provided or referred to as the first repetition factor, the second repetition factor, the third repetition factor, etc.

### Example Implementation 1: Sequence Domain Enhancement

In certain configurations (or specifications), the multiplexing capability of PUCCH in a cell may be determined by the number of initial cyclic shifts. To avoid the insufficient PUCCH capacity, the systems and methods of the technical solution can perform one or more features or operations as discussed herein.

### Example 1 of Example Implementation 1

In various implementations, PUCCH resource sets configuration can be reused/repurposed. For the reused PUCCH resource sets configuration, new indexes can be added to indicate/provide a new PUCCH resource set (e.g., defined set of PUCCH resources) with a corresponding new set of initial cyclic shift (CS) (e.g., CS indexes), which may be received via higher layer signaling. The defined set of PUCCH resources with the corresponding set of initial CS indexes can be included as part of a second indication. For example, at least one of the following can be considered for the reused PUCCH resource sets.
1. In some cases, the pucch-ResourceCommon (0 . . . 15) can be extended to (e.g., 0 . . . z) (e.g., z can be a predetermined or configured, such as but not limited to 19, 20, etc.) in IE PUCCH-ConfigCommon. The new PUCCH resource set with the corresponding new set of initial CS indexes can be provided by PUCCH-ConfigCommon through an index of (16 . . . z), or via other higher layer signalings.
2. In some cases, the new set of initial CS indexes can be any six or eight of {0, 1, 2, 3, 4, 5, 6, 7, 8, 9, 10, 11}.
3. In some cases, whether to enable the enhanced index with new initial cyclic shift can be determined by at least one of the following example conditions/criteria:
   a. When the number of repetition for PUCCH repetition, such as for Msg4 HARQ-ACK, is configured by/via SIB signaling (or other types of signalings),
   b. When the RSRP threshold for determining/deciding whether to perform PUCCH repetition is configured via the SIB signaling,
   c. When a specific number of repetition is indicated by a downlink assignment index (DAI) field in DCI format 1_0,
   d. When the UE 104 capable of PUCCH repetition for Msg4 HARQ-ACK reports the capability of PUCCH repetition (e.g., the UE 104 reports that the UE 104 is capable of supporting PUCCH repetition), e.g., for Msg4 HARQ-ACK, and/or
   e. The PUCCH resource index (e.g., index in the second indication), which may be configured by the pucch-ResourceCommon, is greater/larger than 15.

### Example 2 of Example Implementation 1

In some implementations, PUCCH resource sets configuration can be reused and new indexes can be added to indicate/define a new PUCCH resource set with a corresponding new set of initial CS indexes. For example, at least one of the following can be considered for the reused PUCCH resource sets:
1. In some cases, the pucch-ResourceCommon (0 . . . 15) can be extended to (e.g., 0 . . . z), where z can denote a predetermined or configured, such as but not limited to 19, in IE PUCCH-ConfigCommon. The new PUCCH resource set with the corresponding new set of initial CS indexes can be provided by PUCCH-ConfigCommon through an index of (16 . . . z), or via other higher layer signalings.
2. In some cases, the new set of initial CS indexes can be any six or eight of {0, 1, 2, 3, 4, 5, 6, 7, 8, 9, 10, 11}.
3. In some cases, whether to enable the enhanced index with new initial cyclic shift can be determined by at least one of the following example conditions/criteria:
   a. When the number of repetition for PUCCH repetition, such as for Msg4 HARQ-ACK, is configured by/via SIB signaling (or other types of signalings),
   b. When the RSRP threshold is configured via SIB signaling,
   c. When a specific number of repetition is indicated by the DAI field in DCI format 1_0,
   d. When the UE 104 capable of PUCCH repetition for Msg4 HARQ-ACK reports the capability of PUCCH repetition for Msg4 HARQ-ACK, and/or
   e. The PUCCH resource index (e.g., index in the second indication), which may be configured by the pucch-ResourceCommon, is greater/larger than 15.
4. In some aspects, different initial CSs can correspond to the UE 104 with different repetition factors. The UE 104 with different repetition factors can determine the initial CS in the set of initial CSs according to, for instance, mapping rules (or other conditions/criteria). For example, each UE 104 with a different capability or configuration on repetition factors can be sequentially mapped (e.g., according to the mapping rules) to a respective subset of the corresponding set of initial CS indexes, as discussed herein. The mapping rules (e.g., sequential mapping) can include at least one of but not limited to:
   a. If a single repetition factor is configured, the initial cyclic shifts can belong to or be configured for the UE 104 with repetition activated/enabled and the UE 104 (e.g., another UE) with repetition disabled each occupy half of the set;
   b. If two repetition factors (e.g., a first factor and a second factor, where the first factor is less than the second factor) are configured, the initial cyclic shifts can belong to the UE 104 with repetition disabled. The UE 104 with first repetition factor and the UE 104 (e.g., another UE) with second repetition factor, respectively, may be {first iCS}, {second iCS, third iCS}, {fourth iCS, fifth iCS, sixth iCS}, or {first iCS, second iCS}, {third iCS, fourth iCS}, {fifth iCS, sixth iCS};
   c. If three repetition factors (e.g., a first factor, a second factor, and a third factor, where the first factor is less than the second factor, and the second factor is less than the third factor) are configured, the initial cyclic shifts can belong to the UE 104 with repetition disabled. The UE 104 with first repetition factor, the UE 104 with second repetition factor, and the UE 104 with third repetition factor, respectively, may be {first iCS}, {second iCS}, {third iCS, fourth iCS}, {fifth iCS, sixth iCS}; and/or
   d. If the repetition factor is absent, passed, or is not configured (or an indication is received indicating that the repetition factor is not configured), or if the UE 104 is not capable of repetition, the initial cyclic shifts for the UE 104 can be determined as a legacy values (or specification).
   e. In some configurations, when one repetition factor corresponds to multiple initial cyclic shifts, UEs 104 with the same repetition factor can determine the initial cyclic shift index in the set of initial cyclic shift as r_{PUCCH} mod N_{CS ′} and/or (r_{pucch}−8)mod N_{CS ′} can be the total number of initial cyclic shift indexes in the set of initial cyclic shift indexes corresponding to one repetition factor.
5. In some cases, the IE PUCCH-ConfigCommon information element configuration can be considered, where pucch-ResourceCommon is used to configure at least one index for the UE 104 with repetition disabled/enabled. For example, the UE 104 may receive/obtain the second indication via at least one of: a PUCCH-ConfigCommon IE, a pucch-ResourceCommonRep field, and/or another field of the PUCCH-ConfigCommon IE, among others, such as provided for instance in the following non-limiting example:

PUCCH-ConfigCommon ::= SEQUENCE {
pucch-ResourceCommon INTEGER (0..z) OPTIONAL, -- Cond
InitialBWP-Only
...
}

For example, the PUCCH resource sets table can be configured according to but not limited to example Table 2.

Example Table 2:
PUCCH resource sets before dedicated PUCCH resource configuration.

| | PUCCH | First | Number of | | Set of initial CS |
|---|---|---|---|---|---|
| Index | format | symbol | symbols | PRB offset | indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | ] $⌊ {N}_{B W P}^{s i z e} / 4 ⌋$ | {0, 3, 6, 9} |
| 16 | 1 | 0 | 14 | 0 | {0, 2, 4, 6, 8, 10} |
| 17 | 1 | 0 | 14 | 2 | {0, 2, 4, 6, 8, 10} |
| 18 | 1 | 0 | 14 | 4 | {0, 2, 4, 6, 8, 10} |
| 19 | 1 | 0 | 14 | [] $⌊ {N}_{B W P}^{s i z e} / 4 ⌋$ | {0, 2, 4, 6, 8, 10} |

Various examples can be provided herein as described in conjunction with the example Table 2. For example, when the number of repetitions is configured by the SIB and the repetition factors is {2,4,8}, for the PUCCH resource set index configured by PUCCH-ConfigCommon, e.g., indexed 16 (or other values), the initial CS {0} can correspond to the UE 104 with repetition disabled. The initial CS {2} can correspond to the UE 104 with repetition factor 2. Initial CS {4,6} can correspond to the UE 104 (e.g., a first UE, or UE1) with repetition factor 4. Initial CS {8,10} can correspond to the UE 104 (e.g., a second UE, or UE2) with repetition factor 8. In this case, the initial CS index of a UE with repetition factor 8 can be r_{pucch1} mod 2. The initial CS index of another UE (e.g., a third UE, or UE3) with repetition factor 8 can be r_{pucch2} mod 2. The initial CS index of yet another UE with repetition factor 8 can be r_{pucch3} mod 2.

In another example, when the number of repetitions is configured by/via SIB signaling (or other types of signaling not limited to SIB) and the repetition factors is {2, 4}, for the PUCCH resource set index configured by PUCCH-ConfigCommon, e.g., indexed 16, initial CS {0} can correspond to the UE 104 with repetition disabled. Initial CS {2,4} can correspond to the UE 104 with repetition factor 2. Initial CS {6,8,10} can correspond to the UE 104 with repetition factor 4. In this case, the initial CS index of UE1 (e.g., a first example UE) with repetition factor 4 can be r_{pucch1} mod 3. The initial CS index of UE2 (e.g., a second example UE) with repetition factor 4 is r_{pucch2} mod 3. The initial CS index of UE3 (e.g., a third example UE) with repetition factor 4 is r_{pucch3} mod 3.

In another example, when the number of repetitions is configured by SIB and the repetition factors is {2, 8}, for the PUCCH resource set index configured by PUCCH-ConfigCommon, e.g., indexed 16, initial CS {0} can correspond to the UE 104 with repetition disabled. Initial CS {2, 4} can correspond to the UE 104 with repetition factor 2. Initial CS {6,8,10} can correspond to the UE 104 with repetition factor 8. In this example, the initial CS index of UEL with repetition factor 8 can be r_{pucch1} mod 3. The initial CS index of UE2 with repetition factor 8 can be r_{pucch2} mod 3. The initial CS index of UE3 with repetition factor 8 can be r_{pucch3} mod 3.

In yet another example, when the number of repetitions is configured by SIB and the repetition factors is {4, 8}, for the PUCCH resource set index configured by PUCCH-ConfigCommon, e.g., indexed 16, initial CS {0} can correspond to the UE 104 with repetition disabled. Initial CS {2, 4} can correspond to the UE 104 with repetition factor 4. Initial CS {6,8, 10} can correspond to the UE 104 with repetition factor 8. In this example, the initial CS index of UEL with repetition factor 8 can be r_{pucch1} mod 3. The initial CS index of UE2 with repetition factor 8 can be r_{pucch2} mod 3. The initial CS index of UE3 with repetition factor 8 can be r_{pucch3} mod 3.

In another example, when the number of repetitions is configured by SIB and the repetition factors is {2}, for the PUCCH resource set index configured by PUCCH-ConfigCommon, e.g., indexed 16, initial CS {0,2,4} can correspond to the UE 104 with repetition disabled. Initial CS {6,8,10} can correspond to the UE 104 with repetition factor 2. In this example, the initial CS index of UE1 with repetition factor 2 can be r_{pucch1} mod 3. The initial CS index of UE2 with repetition factor 2 can be r_{pucch2} mod 3. The initial CS index of UE3 with repetition factor 2 can be r_{pucch3} mod 3.

In another example, when the number of repetitions is configured by SIB and the repetition factors is {4}, for the PUCCH resource set index configured by PUCCH-ConfigCommon, e.g., indexed 16, initial CS {0,2,4} can correspond to the UE 104 with repetition disabled. Initial CS {6,8,10} can correspond to the UE 104 with repetition factor 4. In this example, the initial CS index of UE1 with repetition factor 4 can be r_{pucch1} mod 3. The initial CS index of UE2 with repetition factor 4 can be r_{pucch2} mod 3. The initial CS index of UE3 with repetition factor 4 can be r_{pucch3} mod 3.

In further examples, when the number of repetitions is configured by SIB and the repetition factors is {8}, for the PUCCH resource set index configured by PUCCH-ConfigCommon, e.g., indexed 16, initial CS {0,2,4} can correspond to the UE 104 with repetition disabled. Initial CS {6,8,10} can correspond to the UE 104 with repetition factor 8. In this example, the initial CS index of UE1 with repetition factor 8 can be r_{pucch1} mod 3. The initial CS index of UE2 with repetition factor 8 can be r_{pucch2} mod 3. The initial CS index of UE3 with repetition factor 8 can be r_{pucch3} mod 3.

Additionally or alternatively, when the RSRP threshold is configured via SIB, when the UE 104 capable of PUCCH repetition for Msg4 HARQ-ACK reports the capability of PUCCH repetition for Msg4 HARQ-ACK, and/or when the specific number of repetition is indicated by DAI field in DCI format 1_0, for the PUCCH resource set index {16, . . . , z} configured by PUCCH-ConfigCommon, the UE 104 can determine the initial cyclic shift index in the set of initial cyclic shift indexes according to the mapping rules discussed in the examples herein.

### Example 3 of Example Implementation 1

In some implementations, a new PUCCH resource set table can be provided with a new set of initial CS indexes. At least one of the following example operations or features can be provided for the new PUCCH resource set table with the corresponding set of initial CS indexes:
1. A new table including/containing PUCCH format 1 with 14 OFDM symbols can be added or introduced, creating a new table including 16 indexes by adding a number (e.g., “x”) of new indexes to the example (or existing) indexes 11-15, such as in example Table 1, for example, x can be 4. The x new indexes can include a new set of initial CS indexes. The corresponding set of initial CS indexes can be any six or eight (or in some cases, four) of {0, 1, 2, 3, 4, 5, 6, 7, 8, 9, 10, 11}. The new PUCCH resource set table can be indexed by the value of pucch-ResourceCommonRep, among other values or fields.
2. Whether to enable this table can be determined via/by at least one of the following conditions:
   a. When the number of repetitions for PUCCH repetition for Msg4 HARQ-ACK is configured via SIB,
   b. When the RSRP threshold is configured via SIB,
   c. When the specific number of repetitions is indicated by the DAI field in DCI format 1_0,
   d. When the UE 104 capable of PUCCH repetition for Msg4 HARQ-ACK reports the (e.g., UE) capability of PUCCH repetition for Msg4 HARQ-ACK, and/or
   e. When pucch-ResourceCommonRep is used to configure the index in the new PUCCH resource set table, which may be regardless of whether pucch-ResourceCommon is configured.
3. The different initial cyclic shift can correspond to the UE 104 with different repetition factors. The UE 104 with different repetition factors can determine the initial cyclic shift in the set of initial cyclic shift according to mapping rules. The mapping rules for six initial cyclic shifts and/or four initial cyclic shifts can be described as, but not limited to, at least one of the following:
   a. If a single (or one) repetition factor is configured, all initial cyclic shifts can belong to the UE 104 with the repetition enabled.
   b. If two repetition factors (e.g., a first factor and a second factor, where the first factor is less than the second factor) are configured, the initial cyclic shifts belonging to the UE 104 with the first repetition factor and the UE 104 with the second repetition factor can each occupy half of the set.
   c. If three repetition factors (e.g., a first factor, a second factor, and a third factor, where the first factor is less than the second factor, and the second factor is less than the third factor) and four initial cyclic shifts are configured, the initial cyclic shifts can belong to the UE 104 with first repetition factor, the UE 104 with second repetition factor and the UE 104 with third repetition factor, respectively, can be {first iCS}, {second iCS}, {third iCS, fourth iCS}.
   d. If three repetition factors (e.g., a first factor, a second factor, and a third factor, where the first factor is less than the second factor, and the second factor is less than the third factor) and six initial cyclic shifts are configured, the initial cyclic shifts can belong to the UE 104 with the first repetition factor, the UE 104 with the second repetition factor and the UE 104 with the third repetition factor, respectively, can be {first iCS, second iCS}, {third iCS, fourth iCS}, {fifth iCS, sixth iCS} or {first iCS}, {second iCS, third iCS}, {fourth iCS, fifth iCS, sixth iCS}.
   e. If no repetition factor is configured or the UE 104 does not support (or not capable of) repetition, the UE 104 may not perform repetition. In this case, the initial cyclic shifts for the UE 104 with repetition disabled can be determined as a legacy value.
   f. In some cases, when one repetition factor corresponds to multiple initial cyclic shift, the UEs 104 with the same repetition factor can determine the initial cyclic shift index in the set of initial cyclic shift as

$${r}_{PUCCH} mod {N}_{C S}^{′} and / or ( {r}_{pucch} - 8 ) mod {N}_{C S}^{′}$$

can be the total number of initial cyclic shift indexes in the set of initial cyclic shift indexes corresponding to one repetition factor.
4. IE PUCCH-ConfigCommon information element configuration can be considered. The pucch-ResourceCommon can be used to configure the resource index for the UE 104 with repetition disabled. The pucch-ResourceCommonRep can be used to configure the resource index for the UE 104 with repetition enabled. A non-limiting example can be provided but not limited to the following.

PUCCH-ConfigCommon ::= SEQUENCE {
pucch-ResourceCommon INTEGER (0..15) OPTIONAL, -- Cond
InitialBWP-Only
...
}

For example, the PUCCH resource sets table can be configured or provided as in but not limited to example Table 3.

Example Table 3:
PUCCH resource sets before dedicated PUCCH resource configuration.

| | PUCCH | | Number of | | Set of initial CS |
|---|---|---|---|---|---|
| Index | format | First symbol | symbols | PRB offset | indexes |
| 0 | 1 | 0 | 14 | 0 | {0, 6} |
| 1 | 1 | 0 | 14 | 0 | {0, 3, 6, 9} |
| 2 | 1 | 0 | 14 | 0 | {0, 2, 4, 6, 8, 10} |
| 3 | 1 | 0 | 14 | 2 | {0, 3, 6, 9} |
| 4 | 1 | 0 | 14 | 2 | {0, 2, 4, 6, 8, 10} |
| 5 | 1 | 0 | 14 | 4 | {0, 3, 6, 9} |
| 6 | 1 | 0 | 14 | 4 | {0, 2, 4, 6, 8, 10} |
| 9 | 1 | 0 | 14 | $⌊ {N}_{B W P}^{s i z e} / 4 ⌋$ | {0, 3, 6, 9} |
| 10 | 1 | 0 | 14 | $⌊ {N}_{B W P}^{s i z e} / 4 ⌋$ | {0, 2, 4, 6, 8, 10} |
| 11-15 | reserved | reserved | reserved | reserved | reserved |

Various examples can be provided in view of the example Table 3. For example, when the number of repetitions is configured by SIB and the repetition factors is {2,4,8}, for the PUCCH resource set index configured by PUCCH-ConfigCommonRep, e.g., index 1, 3, 5, or 9, the set of initial cyclic shift can be {0,3,6,9}, initial CS {0} can correspond to the UE 104 with repetition factor 2. Initial CS {3} can correspond to the UE 104 with repetition factor 4. Initial CS {6,9} can correspond to the UE 104 with repetition factor 8.

In another example, when the number of repetitions is configured by SIB and the repetition factors is {2,4,8}, for the PUCCH resource set index configured by PUCCH-ConfigCommonRep, e.g., indexed 2/4/6/10, the set of initial cyclic shift is {0,2,4,6,8,10}, initial CS {0,2} can correspond to the UE 104 with repetition factor 2. Initial CS {4,6} can correspond to the UE 104 with repetition factor 4. Initial CS {8,10} can correspond to the UE 104 with repetition factor 8.

In another example, when the number of repetitions is configured by SIB and the repetition factors is {2,4}, {2,8}, or {4,8}, for the PUCCH resource set index configured by PUCCH-ConfigCommonRep, e.g., indexed 1/3/5/7, the set of initial cyclic shift can be {0,3,6,9}, initial CS {0, 3} can correspond to the UE 104 with repetition factor 2, initial CS {6,9} can correspond to the UE 104 with repetition factor 4. In some cases, the initial CS {0, 3} can correspond to the UE 104 with repetition factor 2, and initial CS {6,9} can correspond to the UE 104 with repetition factor 8. In some cases, the initial CS {0, 3} can correspond to the UE 104 with repetition factor 4, and initial CS {6,9} can correspond to the UE 104 with repetition factor 8.

In another example, when the number of repetitions is configured by SIB and the repetition factors is {2,4}, {2,8}, or {4,8}, for the PUCCH resource set index configured by PUCCH-ConfigCommonRep, e.g., indexed 2, 4, 6, or 10, the set of initial cyclic shift can be {0,2,4,6,8,10}, initial CS {0, 2, 4} can correspond to the UE 104 with repetition factor 2, initial CS {6, 8, 10} can correspond to the UE 104 with repetition factor 4. In some cases, the initial CS {0, 2, 4} can correspond to the UE 104 with repetition factor 2, and initial CS {6, 8, 10} can correspond to the UE 104 with repetition factor 8. In some cases, the initial CS {0, 2, 4} can correspond to the UE 104 with repetition factor 4, and initial CS {6, 8, 10} can correspond to the UE 104 with repetition factor 8.

In another example, when the number of repetitions is configured by SIB and the repetition factors is {2}, {4}, or {8}, for the PUCCH resource set index configured by PUCCH-ConfigCommonRep, the set of initial cyclic shift can be used for UE with the repetition factors, that is, {0,6}, or {0,3,6,9}, or {0,2,4,6,8,10}.

Additionally or alternatively, when the RSRP threshold is configured via SIB, when the UE 104 capable of PUCCH repetition for Msg4 HARQ-ACK reports the capability of PUCCH repetition for Msg4 HARQ-ACK, and/or when the exact number of repetitions is indicated by DAI field in DCI format 1_0 or pucch-ResourceCommonRep (among others) is used to configure index in new PUCCH resource set table, for the PUCCH resource set index configured by PUCCH-ConfigCommonRep, the UE 104 can determine the initial cyclic shift index in the set of initial cyclic shift indexes according to at least one of the mapping rules as discussed herein.

### Example Implementation 2: Frequency Domain Enhancement

In certain configurations (or specifications), the PUCCH resource set may include a constraint or limit of sixteen resources, each corresponding to or associated with a PUCCH format, a first symbol, a duration, a PRB offset, and/or a cyclic shift index set for a PUCCH transmission. The frequency-domain resource (e.g., PRB index of PUCCH transmission) in a slot can be determined by a PRB offset, a PUCCH resource index associated with a number of CCE in a CORESET of a PDCCH reception with DCI (e.g., DCI 1_0, DCI format 1_1, etc.), an index of first CCE for PDCCH reception, which may limit the available frequency resource and/or a value of the PUCCH resource indicator in DCI (e.g., DCI 1_0, DCI format 1_1, etc.).

In certain configurations, if the UE 104 provides HARQ-ACK information in a PUCCH transmission in response to detecting a DCI format scheduling a PDSCH reception or having associated HARQ-ACK information without scheduling a PDSCH reception, the UE 104 may determine a PUCCH resource with index r_{PUCCH}, 0≤r_{PUCCH}≤15, as

$${r}_{PUCCH} = ⌊ \frac{2 \cdot {n}_{CCE , 0}}{{N}_{C C E}} ⌋ + 2 \cdot {Δ}_{P R I} ,$$

where N_{CCE} can be a number of CCEs in a CORESET of a PDCCH reception with the DCI format, N_{CCE,0} can be the index of a first CCE for the PDCCH reception, and Δ_{PRI} can be a value of the PUCCH resource indicator field in the DCI format (e.g., DCI format 1_0 or other DCI formats).

In various arrangements, to avoid insufficient PUCCH capacity, the systems and methods can expand the resources in one set via the one or more operations or features discussed herein. In some implementations, to avoid the insufficient PUCCH capacity, an indication of an additional offset

$$R {B}_{B W P}^{offset - relative}$$

relative to the original cell-common PRB offset

$$R {B}_{B W P}^{offset}$$

in IE PUCCH-ConfigCommon can be defined. For example, the additional offset can be configured as but not limited to −2, 2, 4, and/or 6. In this case, the new PRB offset set can be

$$\{ R {B}_{B W P}^{offset} , {RB}_{B W P}^{offset} + R {B}_{B W P}^{offset - r e l a t ive 1} \} ,$$

$$\{ {RB}_{B W P}^{offset} , {RB}_{B W P}^{offset} + {RB}_{B W P}^{offset - r e l a t ive 1} , {RB}_{B W P}^{offset} + R {B}_{B W P}^{offset - r e l a t ive 2} \} , and / or$$

$$\{ {RB}_{B W P}^{offset} , {RB}_{B W P}^{offset} + R {B}_{B W P}^{offset - r e l ative 1} , {RB}_{B W P}^{offset} + R {B}_{B W P}^{offset - ralative 2} , {RB}_{B W P}^{offset} + {RB}_{B W P}^{offset - relative 3} \} ,$$

etc. The IE PUCCH-ConfigCommon information element can be configured as in the following non-limiting example:

PUCCH-ConfigCommon ::= SEQUENCE {
pucch-ResourceCommon INTEGER (0..15) OPTIONAL, -- Cond
InitialBWP-Only
pucch-PRBoffsetValue INTEGER (−2,2,4,6) OPTIONAL, -- Cond
InitialBWP-Only
...
}

When the pucch-PRBoffsetValue is absent (or not present), the PRB offset can be defined or configured as (in accordance with) the legacy specification. When the pucch-PRBoffsetValue is present, at least one of the following can be considered, applied, or followed.
1. Whether to allow/enable the value (e.g., the pucch-PRBoffsetValue) is determined by at least one of the following conditions:
   a. When the number of repetitions for PUCCH repetition for Msg4 HARQ-ACK is configured via SIB,
   b. When the RSRP threshold is configured via SIB,
   c. When the specific number of repetitions is indicated by/via the DAI field in DCI format 1_0 (or other DCI formats), and/or
   d. When the UE 104 capable of PUCCH repetition for Msg4 HARQ-ACK reports the capability (e.g., the UE 104 capability) of PUCCH repetition for Msg4 HARQ-ACK.
2. When allowing one or multiple additional PRB offsets, the UE 104 can determine the PRB offset index in the set of new PRB offset, for instance, as UE_{ID} mod N_{PRBoffset}, and N_{PRBoffset} may be the total number of PRB offset in the set of new PRB offset.

For example, when pucch-ResourceCommon in PUCCH-ConfigCommon indicates index 14 and the number of repetition for PUCCH repetition for Msg4 HARQ-ACK is configured via SIB (e.g., as part of a condition), the original PRB-offset can be set/configured as 4. If the additional offset is configured as {−2} by pucch-PRBoffsetValue, {2,4} can be used to determine the frequency resource to transmit PUCCH transmission. The PRB offset belonging to the UE 104 can be determined by or according to UE_{ID} mod N_{PRBoffset}.

In another example, when pucch-ResourceCommon in PUCCH-ConfigCommon indicates index 11 or 12 and the number of repetition for PUCCH repetition for Msg4 HARQ-ACK is configured via SIB, the original PRB-offset can be configured as 0. If the additional offset is configured as {2} by pucch-PRBoffsetValue, {0,2} can be used to determine the frequency resource to transmit PUCCH transmission. The PRB offset belonging to the UE 104 can be determined by UE_{ID} mod N_{PRBoffset}.

In another example, when pucch-ResourceCommon in PUCCH-ConfigCommon indicates index 11 or 12 and the number of repetition for PUCCH repetition for Msg4 HARQ-ACK is configured via SIB, the original PRB-offset can be configured as 0. If the additional offset is configured as {2,4} by pucch-PRBoffsetValue, {0,2,4} can be used to determine the frequency resource to transmit PUCCH transmission. The PRB offset belonging to the UE 104 can be determined by UE_{ID} mod N_{PRBoffset}.

In another example, when pucch-ResourceCommon in PUCCH-ConfigCommon indicate index 13 and the number of repetition for PUCCH repetition for Msg4 HARQ-ACK is configured via SIB, the original PRB-offset can be configured as 2. If the additional offset is configured as {2,4} by pucch-PRBoffsetValue, {2,4,6} can be used to determine the frequency resource to transmit PUCCH transmission. The PRB offset belonging to the UE 104 can be determined by UE_{ID} mod N_{PRBoffset}.

Additionally or alternatively, when the RSRP threshold is configured via SIB, when the UE 104 capable of PUCCH repetition for Msg4 HARQ-ACK reports the capability of PUCCH repetition for Msg4 HARQ-ACK, and/or when the exact number of repetitions is indicated by DAI field in DCI format 1_0 (or other DCI formats), the UE 104 can determine the PRB offset index in the set of new PRB offsets according to at least one of the mapping rules.

In some implementations, to avoid the insufficient PUCCH capacity, an additional offset

$$R {B}_{B W P}^{offset - relative}$$

relative to original cell-common PRB offset

$$R {B}_{B W P}^{offset}$$

in E PUCCH-ConfigCommon can be defined. Additional offset can be configured as but not limited to −2, 2, 4, and/or 6. New PRB offset set can include or be

$$\{ {RB}_{B W P}^{offset} , {RB}_{B W P}^{offset} + R {B}_{B W P}^{offset - r e l a t ive 1} \} or$$

$$\{ \{ R {B}_{B W P}^{offset} , {RB}_{B W P}^{offset} + R {B}_{B W P}^{offset - relative 1} , {RB}_{B W P}^{offset} + {RB}_{B W P}^{offset - relative 2} \} ,$$

$$\{ {RB}_{B W P}^{offset} , {RB}_{B W P}^{offset} + R {B}_{B W P}^{offset - r e l a t ive 1} , R {B}_{B W P}^{offset} + R {B}_{B W P}^{offset - r e l a t ive 2} , {RB}_{B W P}^{offset} + {RB}_{B W P}^{offset - r e l a t ive 3} \} ,$$

etc. The IE PUCCH-ConfigCommon information element may be configured or set as in the following non-limiting example:

PUCCH-ConfigCommon ::= SEQUENCE {
pucch-ResourceCommon INTEGER (0..15) OPTIONAL, -- Cond
InitialBWP-Only
pucch-PRBoffsetValue INTEGER (−2,2,4,6) OPTIONAL, -- Cond
InitialBWP-Only
...
}

In some cases, when the pucch-PRBoffsetValue is absent (e.g., not present), the PRB offset can be according to or defined as the legacy specification. In some other cases, when the pucch-PRBoffsetValue is present, the following examples can be considered or applied:
1. Whether to allow/enable the value (e.g., pucch-PRBoffsetValue) can be determined by at least one of the following conditions/criteria:
   a. When the number of repetitions for PUCCH repetition for Msg4 HARQ-ACK is configured via SIB signaling (or other types of signalings),
   b. When the RSRP threshold is configured via SIB signaling,
   c. When the specific number of repetitions is indicated by the DAI field in DCI format 1_0 (or other DCI formats), and/or
   d. When the UE 104 capable of PUCCH repetition for Msg4 HARQ-ACK reports the capability of PUCCH repetition for Msg4 HARQ-ACK.
2. In some cases, one or more additional different offsets (e.g., PRB offsets) can be associated with different repetition factors. For example, each UE 104 with similar or different capability or configuration on repetition factor can be sequentially mapped to a respective subset of the PRB offsets via at least one mapping rule. The mapping rule (e.g., for sequential mapping) can include at least one of the following example conditions:
   a. If one

$$R {B}_{B W P}^{offset - relative 1}$$

is configured,

$$R {B}_{B W P}^{offset}$$

can be used for the UL 104 with repetition disabled to send/transmit/provide/communicate PUCCH transmission.

$$R {B}_{B W P}^{offset} + R {B}_{B W P}^{offset - relative 1}$$

can be used for the UE 104 with first/second/third repetition factors to send PUCCH transmission.
b. If one

$$R {B}_{B W P}^{offset - relative 1}$$

is configured,

$$R {B}_{B W P}^{offset}$$

can be used for the UE 104 with repetition disabled and UEs with first repetition factor to send PUCCH transmission.

$$R {B}_{B W P}^{offset} + R {B}_{B W P}^{offset - relative 1}$$

can be used for the UE 104 with second/third repetition factors to sent PUCCH transmission.
c. If two

$$\{ R {B}_{B W P}^{offset - r e l a t ive 1} , {RB}_{B W P}^{offset - relative 2} \}$$

are configured,

$$R {B}_{B W P}^{offset}$$

can be used for the UL 104 with repetition disabled and the UE 104 with first repetition factor to sent PUCCH transmission.

$$R {B}_{BWP}^{offset} + R {B}_{BWP}^{offset - relative 1}$$

can be used for the UE 104 with second repetition factors to sent PUCCH transmission,

$$R {B}_{BWP}^{offset} + R {B}_{BWP}^{offset - relative 2}$$

can be used for the UE 104 with third repetition factors to send PUCCH transmission.
d. If three

$$\{ R {B}_{BWP}^{offset - relative 1} , {RB}_{BWP}^{offset - relative 2} , {RB}_{BWP}^{offset - relative 3} \}$$

are configured,

$$R {B}_{BWP}^{offset}$$

can be used for the UE 104 with repetition disabled to send PUCCH transmission.

$${RB}_{BWP}^{offset} + {RB}_{BWP}^{offset - relative 1}$$

can be used for the UE 104 with first repetition factors to sent PUCCH transmission,

$$R {B}_{BWP}^{offset} + {RB}_{BWP}^{offset - relative 2}$$

can be used for the UE 104 with second repetition factors to sent PUCCH transmission,

$$R {B}_{BWP}^{offset} + {RB}_{BWP}^{offset - relative 3}$$

can be used for the UE 104 with third repetition factors to sent PUCCH transmission.

Various examples can be provided according to at least one of the example mapping rules. For example, when the number of repetition for PUCCH repetition for Msg4 HARQ-ACK is configured via SIB, if pucch-PRBoffsetValue indicates one PRB offset

$${RB}_{BWP}^{offset - relative 1} , R {B}_{BWP}^{offset}$$

is used for UE with repetition disabled to send/perform the PUCCH transmission.

$$R {B}_{BWP}^{offset} + R {B}_{BWP}^{offset - relative 1}$$

is used for UE with first/second/third repetition factors to sent PUCCH transmission.

In another example, when the number of repetition for PUCCH repetition for Msg4 HARQ-ACK is configured via SIB signaling, if pucch-PRBoffsetValue indicates one PRB offset

$$R {B}_{BWP}^{offset - relative 1} , R {B}_{BWP}^{offset}$$

can be used for the UE 104 with repetition disabled and UEs with first repetition factor to send PUCCH transmission.

$$R {B}_{BWP}^{offset} + R {B}_{BWP}^{offset - relative 1}$$

can be used for the UE 104 with second/third repetition factors to send/perform the PUCCH transmission.

In another example, when the number of repetition for PUCCH repetition for Msg4 HARQ-ACK is configured via SIB signaling, if pucch-PRBoffsetValue indicates two PRB offsets

$$\{ R {B}_{BWP}^{offset - relative 1} , R {B}_{BWP}^{offset - relative 2} \} , R {B}_{BWP}^{offset}$$

can be used for the UE 104 with repetition disabled and the UE 104 with the first repetition factor to send PUCCH transmission.

$$R {B}_{BWP}^{offset} + R {B}_{BWP}^{offset - relative 1}$$

can be used for the UE 104 with second repetition factors to sent PUCCH transmission,

$$R {B}_{BWP}^{offset} + R {B}_{BWP}^{offset - relative 2}$$

can be used for the UE 104 with third repetition factors to sent PUCCH transmission.

In another example, when the number of repetition for PUCCH repetition for Msg4 HARQ-ACK is configured via SIB signaling, if pucch-PRBoffsetValue indicates two PRB offsets

$$\{ R {B}_{BWP}^{offset - relative 1} , {RB}_{BWP}^{offset - relative 2} , R {B}_{BWP}^{offset - relative 3} \}$$

are configured

$$R {B}_{B W P}^{offset}$$

can be used for the UE 104 with repetition disabled to sent PUCCH transmission.

$$R {B}_{BWP}^{offset} + R {B}_{BWP}^{offset - relative 1}$$

can be used for the UE 104 with first repetition factors to sent PUCCH transmission,

$$R {B}_{B W P}^{offset} + R {B}_{B W P}^{offset - r e l a t ive 2}$$

can be used for the UE 104 with second repetition factors to sent PUCCH transmission,

$$R {B}_{B W P}^{offset} + R {B}_{B W P}^{offset - r e l a t ive 3}$$

can be used for the UE 104 with third repetition factors to send PUCCH transmission.

Additionally or alternatively, when the RSRP threshold is configured via SIB signaling, when the UE 104 capable of PUCCH repetition for Msg4 HARQ-ACK reports the capability of PUCCH repetition for Msg4 HARQ-ACK, and/or when the specific number of repetitions is indicated by DAI field in DCI format 1_0 (or other DCI formats), the UE 104 can determine the PRB offset index in the set of new PRB offsets according to at least one of the mapping rules.

In some implementations, to avoid/prevent insufficient PUCCH capacity, the resources can be expanded in one set. In some cases, for example, at least one existing 1-bit field in the DCI (e.g., DAI field, modulation and coding scheme (MCS) field, reserved field in DCI format 1_0, etc.) can be repurposed/reutilized to expand or form a range of the resources (e.g., PUCCH resource indicator (PRI)) in one PUCCH resource set. The 1 bit can serve as the highest or lowest bit of PUCCH resource indicator. For instance, the value of Δ_{PRI} can be changed from (0-7) to (0-15), among other configurable values. In some cases, new aggregation level 32 can be defined which may include, for example, 32 CCEs in a CORESET of a PDCCH. Via combining PUCCH resource indicator Δ_{PRI} with

$$⌊ \frac{2 \cdot {n}_{CCE , 0}}{{N}_{C C E}} ⌋ ,$$

the number of supported PUCCH resources may be expanded from 16 (e.g., in certain systems) to at least 32, among other values, depending on the configurations. At least one of the following features can be considered for reusing the existing 1-bit field in DCI.
1. Whether to re-interpret the existing (or current) 1-bit field in DCI as the highest or lowest bit of PUCCH resource indicator for instance to expand the number of PUCCH resources can be determined via or by following at least one the following conditions:
   a. When the number of repetitions for PUCCH repetition for Msg4 HARQ-ACK can be configured via the SIB signaling,
   b. When the RSRP threshold can be configured via the SIB signaling,
   c. When the specific number of repetitions can be indicated by the DAI field in the DCI format 1_0, and/or
   d. When the UE 104 capable of PUCCH repetition for Msg4 HARQ-ACK reports the capability of PUCCH repetition for Msg4 HARQ-ACK.
2. In some cases, the UE 104 can determine the PUCCH resource index and PRB index according to at least one of the following:
   a. The UE 104 can determine a PUCCH resource with index r_{PUCCH}, 0≤r_{PUCCH}≤32, as

$${r}_{PUCCH} = ⌊ \frac{2 \cdot {n}_{CCE , 0}}{{N}_{C C E}} ⌋ + 2 \cdot {Δ}_{P R I} ,$$

where N_{CCE} can be a number of CCEs in a CORESET of a PDCCH reception with the DCI format, n_{CCE,0} can be the index of a first CCE for the PDCCH reception, and/or Δ_{PRI} can be a value of the PUCCH resource indicator field in the DCI format (e.g., DCI format 1_0 or other DCI formats).
b. If └r_{PUCCH}/16┘=0 and the UE 104 is provided a PUCCH resource by pucch-ResourceCommon and is not provided useInterlacePUCCH-PUSCH in BWP-UplinkCommon, at least one of the following examples can be considered:
   i. The UE 104 can determine the lowest PRB index of the PUCCH transmission in the first hop as

$$R {B}_{B W P}^{offset} \cdot {N}_{R B} + ⌊ {r}_{P U C C H} / {N}_{C S} ⌋ \cdot {N}_{R B}$$

and the lowest PRB index of the PUCCH transmission in the second hop as

$${N}_{B W P}^{s i z e} - R {B}_{B W P}^{offset} \cdot {N}_{R B} - ( 1 + ⌊ {r}_{P U C C H} / {N}_{C S} ⌋ ) \cdot {N}_{R B} ,$$

where N_{CS} can be the total number of initial cyclic shift indexes in the set of initial cyclic shift indexes, and N_{RB}=1.
ii. The UE 104 can determine the initial cyclic shift index in the set of initial cyclic shift indexes as r_{PUCCH} mod N_{CS}.
c. If └r_{PUCCH}/16┘=1 and the UE 104 is provided a PUCCH resource by pucch-ResourceCommon and is not provided useInterlacePUCCH-PUSCH in BWP-UplinkCommon, at least one of the following examples can be considered:
   i. The UE 104 can determine the lowest PRB index of the PUCCH transmission in the first hop as

$${N}_{B W P}^{s i z e} - R {B}_{B W P}^{offset} \cdot {N}_{R B} - ( 1 + ⌊ ( {r}_{PUCCH} - 16 ) / {N}_{C S} ⌋ ) \cdot {N}_{R B}$$

and the lowest PRB index of the PUCCH transmission in the second hop

$$R {B}_{B W P}^{offset} \cdot {N}_{R B} + ⌊ ( {r}_{P UCCH} - 16 ) / {N}_{C S} ⌋ \cdot {N}_{R B} ,$$

where N_{RB}=1.
ii. The UE 104 can determine the initial cyclic shift index in the set of initial cyclic shift indexes as (r_{PUCCH}−16)mod N_{CS}.
3. In some cases, the expansion of the PUCCH resource (e.g., to 32) can be associated with different repetition factors, for example.

Various examples can be provided according to the various example features for reusing the existing 1-bit field in DCI. For example, when the number of repetitions for PUCCH repetition for Msg4 HARQ-ACK is configured via SIB signaling, the UE 104 can interpret or identify the existing 1-bit field in DCI as the highest or lowest bit of PUCCH resource indicator. The UE 104 can determine the PUCCH resource index and PRB index according to at least one of the features discussed hereinabove.

Additionally or alternatively, when the RSRP threshold is configured via SIB, when the UE 104 capable of PUCCH repetition for Msg4 HARQ-ACK reports the capability of PUCCH repetition for Msg4 HARQ-ACK, and/or when the specific number of repetitions is indicated by DAI field in DCI format 1_0 (or other DCI formats), the UE 104 can interpret the existing 1-bit field in DCI as the highest or lowest bit of PUCCH resource indicator. Further, the UE 104 can determine the PUCCH resource index and PRB index according to at least one of the features discussed hereinabove.

By increasing the number of PRB offset and initial cyclic shifts, and expanding the number of PUCCH resource in one set, the number of PUCCH resources in a slot can increase (e.g., exponentially), thereby alleviating or preventing insufficient PUCCH capacity scenarios. In some implementations, to further alleviate the insufficient PUCCH capacity scenarios, the example implementations 1 and 2 may be performed in combination, for example.

### Example Implementation 3: RSRP Threshold Configuration for PUCCH Repetition

In certain embodiments, for transmission trigger (e.g., triggering/initiating the transmission) of UE information for PUCCH repetition, a new RSRP threshold may be introduced, where the RSRP threshold value may be configured or predetermined. In some aspects, for PUCCH repetition for Msg4 HARQ-ACK, an RSRP threshold can be configured via SIB, for instance, at least when the number of repetitions is configured by SIB. If the RSRP threshold is configured, the UE 104 capable of PUCCH repetition for Msg4 HARQ-ACK can report the capability (of the UE 104) of PUCCH repetition for Msg4 HARQ-ACK, if the measured RSRP is less/lower than the configured RSRP threshold. If the RSRP threshold is not configured, the UE 104 capable of PUCCH repetition for Msg4 HARQ-ACK can report the capability of PUCCH repetition for Msg4 HARQ-ACK. For the RSRP threshold introduced for PUCCH repetition, the same value between the new RSRP threshold for PUCCH repetition and the RSRP threshold for Msg3 repetition of certain systems (e.g., legacy RSRP threshold) can be configured by implementation/configuration of the BS 102. The range of RSRP threshold for PUCCH repetition for Msg4 HARQ-ACK may be similar to (or the same as) the range of the RSRP threshold for Msg3 repetition of certain systems.

In various configurations, at least one of the following can be considered for the RSRP threshold value:
1. The RSRP threshold for PUCCH repetition for Msg4 HARQ-ACK can be an absolute value. The range of RSRP threshold for PUCCH repetition for Msg4 HARQ-ACK may be the same as the range of the RSRP threshold for Msg3 repetition of certain systems.
2. The RSRP threshold for PUCCH repetition for Msg4 HARQ-ACK can be a relative value, such as discussed as follows:
   a. The range of RSRP threshold for PUCCH repetition for Msg4 HARQ-ACK may be the same as the range of the RSRP threshold for Msg3 repetition of certain systems.
   b. The relative value can be {−5, . . . , 10} configured by high layer signaling (or other types of signalings), such as SIB signaling, MAC CE signaling, RRC signaling, or other signalings, where:
      i. The relative value can occupy 3-bits ranging from (0, . . . , 7), or 4 bit ranging from (0, . . . , 15),
      ii. Zero value can indicate/mean that the RSRP threshold for PUCCH repetition is the same as Msg3 repetition of certain systems, for instance:
         1. The RSRP threshold for PUCCH repetition may be the same as RSRP threshold for the Msg3 repetition if the RSRP threshold for the Msg3 repetition is configured, and/or
         2. The RSRP threshold for PUCCH repetition may not be configured if the RSRP threshold for the Msg3 repetition is not configured.
   c. Non-zero value can indicate that the RSRP threshold for PUCCH repetition is the RSRP threshold for the Msg3 repetition plus or minus the non-zero value.

Various examples can be provided for the RSRP threshold value implementations. For example, the definition of the RSRP threshold for PUCCH repetition can correspond to or refer to a relative value. If the RSRP threshold for Msg3 repetition is configured, the relative value can be configured as 2 dB, the RSRP threshold for PUCCH repetition can be the RSRP threshold for the Msg3 repetition plus or minus the 2 dB. The UE 104 capable of PUCCH repetition for Msg4 HARQ-ACK can report the capability of PUCCH repetition for Msg4 HARQ-ACK if the measured RSRP is lower than the configured RSRP threshold, for example. If the relative value is absent (not present), the UE 104 capable of PUCCH repetition for Msg4 HARQ-ACK can report the capability of PUCCH repetition for Msg4 HARQ-ACK.

In another example, the definition of the RSRP threshold for PUCCH repetition can refer to a relative value. If the RSRP threshold for the Msg3 repetition is configured, the relative value can be configured as 0 dB, the RSRP threshold for PUCCH repetition can be the same as the RSRP threshold for the Msg3 repetition. The UE 104 capable of PUCCH repetition for Msg4 HARQ-ACK can report the capability of PUCCH repetition for Msg4 HARQ-ACK if the measured RSRP is lower than the configured RSRP threshold. If the relative value is absent, the UE 104 capable of PUCCH repetition for Msg4 HARQ-ACK can report the capability of PUCCH repetition for Msg4 HARQ-ACK.

In yet another example, the definition of the RSRP threshold for PUCCH repetition can refer to a relative value. If the RSRP threshold for the Msg3 repetition is not configured, the relative value can be configured as 0 dB, the RSRP threshold for PUCCH repetition may not be configured. The UE 104 capable of PUCCH repetition for Msg4 HARQ-ACK can report the capability of PUCCH repetition for Msg4 HARQ-ACK. If the relative value is absent, the UE 104 capable of PUCCH repetition for Msg4 HARQ-ACK can report the capability of PUCCH repetition for Msg4 HARQ-ACK.

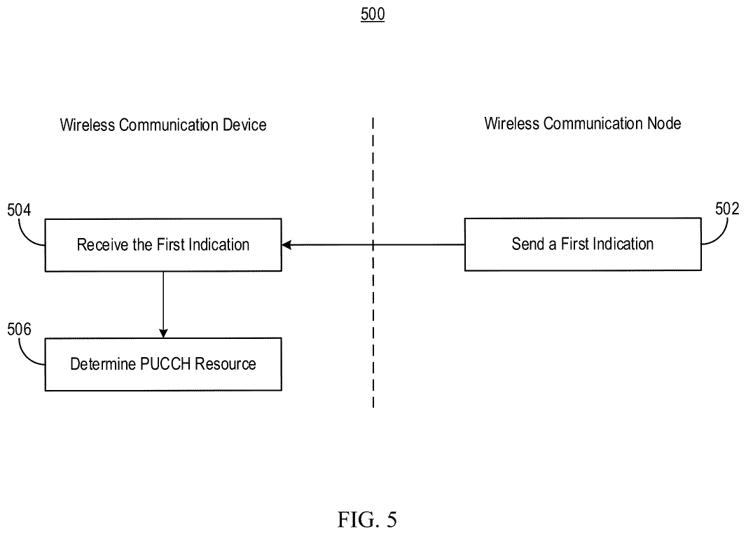

FIG. 5 illustrates a flow diagram of an example method 500 for capacity expansion of control channel. The method 500 may be implemented using any one or more of the components and devices detailed herein in conjunction with FIGS. 1-4. In brief overview, the method 500 may be performed by at least one wireless communication device (e.g., a UE or terminal device), at least one wireless communication node (e.g., a BS, gNB, TRP, or access network equipment), at least one satellite, etc., in some embodiments. Additional, fewer, or different operations may be performed in the method 500 depending on the embodiment. At least one aspect of the operations is directed to a system, method, apparatus, or a computer-readable medium.

At operation 502, a wireless communication node can send/transmit/provide a first indication of a physical uplink control channel (PUCCH) resource for PUCCH transmission to a wireless communication device. At operation 504, the wireless communication device can receive/acquire/obtain the first indication from the wireless communication node. At operation 506, the wireless communication device can determine (e.g., according to the first indication) the PUCCH resource to perform the PUCCH transmission.

In some implementations, the PUCCH resource can include at least one of: a PUCCH resource (e.g., dedicated to the wireless communication device) for PUCCH transmission for a msg4 hybrid automatic repeat request acknowledgement (HARQ-ACK), a PUCCH resource for PUCCH transmission with repetition, for a msg4 HARQ-ACK, a common PUCCH resource for PUCCH transmission, and/or a common PUCCH resource (e.g., shared with other wireless communication devices) for PUCCH transmission with repetition.

In some implementations, the first indication can include one or more indications. For example, the first indication can comprise at least one of: a second indication: comprising an index to indicate a defined set of PUCCH resources with a corresponding set of initial cyclic shift (CS) indexes, received via higher layer signaling (e.g., SIB signaling, MAC CE signaling, RRC signaling, or other signalings), a third indication: comprising at least one physical resource block (PRB) offset, received via higher layer signaling, a fourth indication: comprising at least one PRB offset relative to a cell-common PRB offset value, received via higher layer signaling, and/or a fifth indication: comprising an indicator in downlink control information (DCI) signaling to indicate to the wireless communication device to expand resources in one PUCCH resource set. In some cases, the indicator can be included in at least one of: a downlink assignment index (DAI) field, a modulation and coding scheme (MCS) field, and/or a reserved field, for instance, in DCI format 1_0 (or other DCI formats). In some implementations, the higher layer signaling can be at least one of system information block (SIB) signaling, medium access control (MAC) signaling, radio resource control (RRC) signaling, and/or other signalings.

In some implementations, the corresponding set of initial CS indexes can include: four, six, or eight initial CS indexes, depending on the configuration. In some implementations, each wireless communication device with a different capability or configuration on repetition factors (e.g., wireless communication devices not capable of repetition or wireless devices configured with a specific repetition factor) can be sequentially mapped (e.g., according to one or more mapping rules) to a respective subset of the corresponding set of initial CS indexes. The sequential mapping or the mapping rules can include at least one of: initial CS indexes belonging to a wireless communication device with repetition enabled and a wireless communication device with repetition disabled, each occupy half of the corresponding set of initial CS indexes when only a single repetition factor is configured; all of the initial CS indexes belong to a wireless communication device with repetition enabled when only a single repetition factor is configured; initial CS indexes belonging to a wireless communication device with repetition disabled, a wireless communication device with a first repetition factor and a wireless communication device with a second repetition factor respectively are {first initial CS index}, {second initial CS index, third initial CS index}, {fourth initial CS index, fifth initial CS index, sixth initial CS index} when only two repetition factors are configured; initial CS indexes belonging to a wireless communication device with repetition disabled, a wireless communication device with a first repetition factor and a wireless communication device with a second repetition factor respectively are {first initial CS index, second initial CS index}, {third initial CS index, fourth initial CS index}, {fifth initial CS index, sixth initial CS index} when only two repetition factors are configured; initial CS indexes belonging to a wireless communication device with first repetition factor and a wireless communication device with second repetition factor each occupy half of the corresponding set of initial CS indexes when only two repetition factors are configured; initial CS indexes belonging to a wireless communication device with repetition disabled, a wireless communication device with a first repetition factor, a wireless communication device with a second repetition factor and a wireless communication device with a third repetition factor respectively are {first initial CS index}, {second initial CS index}, {third initial CS index, fourth initial CS index}, {fifth initial CS index, sixth initial CS index} when only three repetition factors are configured; initial CS indexes belonging to a wireless communication device with a first repetition factor, a wireless communication device with a second repetition factor and a wireless communication device with a third repetition factor respectively are {first initial CS index}, {second initial CS index}, {third initial CS index, fourth initial CS index} when only three repetition factors and four initial CS indexes are configured; initial cyclic shifts belonging to a wireless communication device with a first repetition factor, a wireless communication device with a second repetition factor and a wireless communication device with a third repetition factor respectively are {first initial CS index, second initial CS index}, {third initial CS index, fourth initial CS index}, {fifth initial CS index, sixth initial CS index}, when only three repetition factors and six initial CS indexes are configured; initial CS indexes belonging to a wireless communication device with a first repetition factor, a wireless communication device with a second repetition factor and a wireless communication device with a third repetition factor respectively are {first initial CS index}, {second initial CS index, third initial CS index}, {fourth initial CS index, fifth initial CS index, sixth initial CS index} when only three repetition factors and six initial CS indexes are configured, and/or initial CS indexes for a wireless communication device is determined as legacy values when no repetition factor is configured or when the wireless communication device is not capable of repetition.

In some implementations, for wireless communication devices with the same capability (or support) or configuration on repetition factors, each respective wireless communication device can be determined to have a specific initial CS index according to at least one of:

$${r}_{PUCCH} mod {N}_{C S}^{′} ,$$

and/or

$$( {r}_{pucch} - 8 ) mod {N}_{C S}^{′} .$$

### The

$${N}_{C S}^{′}$$

can be a total number of initial CS indexes in the corresponding set of initial CS indexes corresponding to one repetition factor. The r_{pucch} can be a PUCCH index of the respective wireless communication device.

In some implementations, the second indication may be received via at least one of: a PUCCH-ConfigCommon information element (IE), a pucch-ResourceCommonRep field, and/or another field of the PUCCH-ConfigCommon IE. In some implementations, at least one of: the third indication (e.g., for frequency domain enhancement) can include/comprise at least one PRB offset

$$( R {B}_{B W P}^{offset} )$$

in frequency domain; and/or the fourth indication can include at least one PRB offset

$$( R {B}_{B W P}^{offset - r e l a t i v e} )$$

relative to a cell-common PRB offset value. The at least one PRB offset can comprise at least one of but not limited to: −2, 0, 2, 4, 6, {−1, 2}, {4, 6}, or another integer value.

In some implementations, the third or fourth indication may be received/acquired via at least one of: a PUCCH-ConfigCommon information element (IE) and/or a pucch-PRBoffsetValue field. In some implementations, each wireless communication device with a different capability or configuration on repetition factor (e.g., wireless communication devices not capable of repetition, wireless communication devices with a specific repetition factor, etc.), can be sequentially mapped to a respective subset of the at least one PRB offset. The sequential mapping (e.g., mapping rules) can include but not limited to at least one of:

$${RB}_{B W P}^{offset}$$

can be used for a wireless communication device with repetition disabled for PUCCH transmission,

$$R {B}_{BWP}^{offset} + R {B}_{BWP}^{offset - relative 1}$$

can be used for a wireless communication device with a first, second or third repetition factor for PUCCH transmission, when only one

$$R {B}_{B W P}^{offset - relative 1}$$

is configured; and/or

$$R {B}_{B W P}^{offset}$$

can be used for a wireless communication device with repetition disabled and for a wireless communication device with a first repetition factor for PUCCH transmission,

$$R {B}_{BWP}^{offset} + R {B}_{BWP}^{offset - relative 1}$$

can be used for a wireless communication device with a second or third repetition factor for PUCCH transmission, when only

$$R {B}_{BWP}^{offset - relative 1}$$

is configured; and/or

$$R {B}_{B W P}^{offset}$$

can be used for a wireless communication device with repetition disabled and a wireless communication device with a first repetition factor for PUCCH transmission,

$$R {B}_{B W P}^{offset} + R {B}_{B W P}^{offset - relative 1}$$

can be used for a wireless communication device with a second repetition factor for PUCCH transmission,

$$R {B}_{B W P}^{offset} + R {B}_{B W P}^{offset - relative 2}$$

be used for a wireless communication device with a third repetition factor for PUCCH transmission, when

$$\{ R {B}_{B W P}^{offsetirelative 1} , {RB}_{BWP}^{offet - relative 2} \}$$

are configured; and/or

$$R {B}_{B W P}^{offset}$$

can be used for a wireless communication device with repetition disabled for PUCCH transmission,

$$R {B}_{B W P}^{offset} + R {B}_{BWP}^{offset - relative 1}$$

can be used for a wireless communication device with a first repetition factor for PUCCH transmission,

$$R {B}_{B W P}^{offset} + R {B}_{B W P}^{offset - relative 2}$$

can be used for a wireless communication device with a second repetition factor for PUCCH transmission,

$$R {B}_{B W P}^{offset} + R {B}_{B W P}^{offset - relative 3}$$

can be used for a wireless communication device with a third repetition factor for PUCCH transmission, when

$$\{ {RB}_{B W P}^{offset - relative 1} , {RB}_{B W P}^{offset - relative 2} , {RB}_{B W P}^{offset - relative 3} \}$$

are configured.

In some implementations, for wireless communication devices with the same capability or configuration on repetition, each respective wireless communication device can be determined to use a specific PRB offset according to one of: UE_{ID} mod N_{PRBoffset}, when multiple PRB offsets are configured, where N_{PRBoffset} may be a total number of PRB offsets defined, UE_{ID} can be a wireless communication device network identification which can include at least one of: a Cell-Radio Network Temporary Identifier (C-RNTI), a Temporary Cell-Radio Network Temporary Identifier (TC-RNTI), an International Mobile Subscriber Identity (IMSI), and/or another identifier of the respective wireless communication device.

In some implementations, the fifth indication can comprise one or more bits in a DAI field or MCS field or reserved field in DCI format 1_0, that expands or forms a range (e.g., from 16 to 32, etc.) of a PUCCH resource indicator (PRI). In some implementations, determining the PUCCH resource can include: the wireless communication device can determine the PUCCH resource to perform the PUCCH transmission, when a condition associated with the first indication is met. The condition associated with the first indication being met can include at least one of but not limited to: a number of repetition for PUCCH repetition is configured via system information block (SIB) signaling; a reference signal received power (RSRP) threshold for determining whether to perform PUCCH repetition is configured via SIB signaling; a specific number of repetition is indicated by a downlink assignment index (DAI) field in downlink control information (DCI) format 1_0; the wireless communication device reporting that the wireless communication device is capable of supporting PUCCH repetition; an index in a second indication is larger than 15; and/or a pucch-ResourceCommonRep field is used to configure an index in a PUCCH resource set table regardless of whether a pucch-ResourceCommon field is configured or not. The PUCCH repetition can include repetition of at least one of: PUCCH for Msg4 hybrid automatic repeat request acknowledgement (HARQ-ACK), and/or common PUCCH.

In some implementations, at least one of: the RSRP threshold can be configured via higher layer signaling; when a measured RSRP is below the RSRP threshold, the wireless communication device may report its capability to support PUCCH repetition; when the RSRP threshold is not configured, the wireless communication device may report its capability to support PUCCH repetition; the RSRP threshold may be an absolute value or a relative value; and/or the relative value can be relative to a defined or legacy RSRP threshold (e.g., RSRP threshold for Msg3 repetition of certain systems).

In some implementations, when the relative value is zero, at least one of: the RSRP threshold for PUCCH repetition may be the same as a defined or legacy RSRP threshold (e.g., RSRP threshold for Msg3 repetition of certain systems) if the defined or legacy RSRP threshold is configured, and/or the RSRP threshold for PUCCH repetition may not be configured if the defined or legacy RSRP threshold is not configured.

In some implementations, when the relative value is non-zero, at least one of: the RSRP threshold for PUCCH repetition is the defined or legacy RSRP threshold plus the non-zero value, and/or the RSRP threshold for PUCCH repetition is the defined or legacy RSRP threshold minus the non-zero value.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according to embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
determining, by a wireless communication device, a physical uplink control channel (PUCCH) resource to perform a PUCCH transmission with repetition, for a msg4 hybrid automatic repeat request acknowledgement (HARQ-ACK); and
performing, by the wireless communication device, the PUCCH transmission using the PUCCH resource.

2. The method of claim 1, wherein determining the PUCCH resource comprises:
determining, by the wireless communication device, the PUCCH resource to perform the PUCCH transmission, when a number of repetition for PUCCH repetition is configured via system information block (SIB) signaling.

3. The method of claim 1, comprising:
receiving, by the wireless communication device, a system information block (SIB) signaling indicating a reference signal received power (RSRP) threshold.

4. The method of claim 3, comprising:
determining, by the wireless communication device, whether a measured reference signal received power (RSRP) is lower than a RSRP threshold.

5. The method of claim 3, comprising:
reporting, by the wireless communication device when the wireless communication device is capable of PUCCH repetition for msg4 HARQ-ACK and when a measured reference signal received power (RSRP) is lower than the RSRP threshold, a capability of the wireless communication device for the PUCCH repetition for msg4 HARQ-ACK.

6. A method comprising:
receiving, by a wireless communication node from a wireless communication device, a physical uplink control channel (PUCCH) transmission using a PUCCH resource,
wherein the PUCCH resource is for performing the PUCCH transmission with repetition, for a msg4 hybrid automatic repeat request acknowledgement (HARQ-ACK.

7. The method of claim 6, wherein the PUCCH resource is for performing the PUCCH transmission, when a number of repetition for PUCCH repetition is configured via system information block (SIB) signaling.

8. The method of claim 6, comprising:
transmitting, by the wireless communication node to the wireless communication device, a system information block (SIB) signaling indicating a reference signal received power (RSRP) threshold.

9. The method of claim 7, wherein the SIB signaling causes the wireless communication device to determine whether a measured reference signal received power (RSRP) is lower than a RSRP threshold.

10. The method of claim 7, comprising:
receiving, by the wireless communication node from the wireless communication device, when the wireless communication device is capable of PUCCH repetition for msg4 HARQ-ACK and when a measured reference signal received power (RSRP) is lower than the RSRP threshold, a report of a capability of the wireless communication device for the PUCCH repetition for msg4 HARQ-ACK.

11. A wireless communication device comprising:
at least one processor configured to:
determine a physical uplink control channel (PUCCH) resource to perform a PUCCH transmission with repetition, for a msg4 hybrid automatic repeat request acknowledgement (HARQ-ACK); and
perform, via a transmitter, the PUCCH transmission using the PUCCH resource.

12. The wireless communication device of claim 11, wherein the at least one processor is configured to determine the PUCCH resource to perform the PUCCH transmission, when a number of repetition for PUCCH repetition is configured via system information block (SIB) signaling.

13. The wireless communication device of claim 11, wherein the at least one processor is configured to receive, via a receiver, a system information block (SIB) signaling indicating a reference signal received power (RSRP) threshold.

14. The wireless communication device of claim 13, wherein the at least one processor is configured to determine whether a measured reference signal received power (RSRP) is lower than a RSRP threshold.

15. The wireless communication device of claim 13, wherein the at least one processor configured to report, via the transmitter, when the wireless communication device is capable of PUCCH repetition for msg4 HARQ-ACK and when a measured reference signal received power (RSRP) is lower than the RSRP threshold, a capability of the wireless communication device for the PUCCH repetition for msg4 HARQ-ACK.

16. A wireless communication node comprising:
at least one processor configured to:
receive, via a receiver from a wireless communication device, a physical uplink control channel (PUCCH) transmission using a PUCCH resource,
wherein the PUCCH resource is for performing the PUCCH transmission with repetition, for a msg4 hybrid automatic repeat request acknowledgement (HARQ-ACK.

17. The wireless communication node of claim 16, wherein the PUCCH resource is for performing the PUCCH transmission, when a number of repetition for PUCCH repetition is configured via system information block (SIB) signaling.

18. The wireless communication node of claim 16, wherein the at least one processor is configured to transmit, via a transmitter to the wireless communication device, a system information block (SIB) signaling indicating a reference signal received power (RSRP) threshold.

19. The wireless communication node of claim 17, wherein the SIB signaling causes the wireless communication device to determine whether a measured reference signal received power (RSRP) is lower than a RSRP threshold.

20. The wireless communication node of claim 17, wherein the at least one processor is configured to receive, via the receiver from the wireless communication device, when the wireless communication device is capable of PUCCH repetition for msg4 HARQ-ACK and when a measured reference signal received power (RSRP) is lower than the RSRP threshold, a report of a capability of the wireless communication device for the PUCCH repetition for msg4 HARQ-ACK.
